(19) United States
(12) Patent Application Publication
(10) Pub. No.: US 2013/0067566 A1
(43) Pub. Date: Mar. 14, 2013

(54) DEVICE TO PERFORM AUTHENTICATION ACCORDING TO SURROUNDING INFORMATION AND METHOD FOR PERFORMING AUTHENTICATION

(71) Applicant: Jeong-Won OH, Seoul (KR)

(72) Inventor: Jeong-Won OH, Seoul (KR)

(73) Assignee: PANTECH CO., LTD., Seoul (KR)

(21) Appl. No.: 13/455,330

(22) Filed: Apr. 25, 2012

(30) Foreign Application Priority Data
Sep. 9, 2011 (KR) 10-2011-0092115

(51) Int. Cl. H04L 9/32; G06F 21/00

(52) U.S. Cl. 726/19

(57) ABSTRACT

A device to authenticate a user includes a user interface unit to receive a password input; a surrounding information detecting unit to detect surrounding information of the device; and an authentication unit to authenticate the password input and to determine whether the surrounding information matches preset surrounding information. A method for performing authentication includes receiving an authentication input for authenticating a user; determining whether an authentication condition is satisfied, based on surrounding information of a device; and authenticating the authentication input.

### CROSS-REFERENCE TO RELATED APPLICATION

This application claims priority from and the benefit under 35 U.S.C. §119(a) of Korean Patent Application No. 10-2011-0092115, filed on Sep. 9, 2011, which is hereby incorporated by reference for all purposes as if fully set forth herein.

### BACKGROUND

1. Field

The following description relates to a device to perform authentication according to surrounding information and a method for performing authentication according to the surrounding information.

2. Discussion of the Background

For a security purpose an electronic device may be locked by registering a password chosen by a user and may be unlocked when the user enters the password. With the development of a security function, the combination of characters and numbers or pattern recognition has been introduced to lock and unlock a device. However, it is inconvenient to enter complicated and long passwords consisting of the combination of characters and numbers in a device having a limited size and a limited interface. On the other hand, a password having simple pattern is more likely to be easily identified by others.

### SUMMARY

Exemplary embodiments of the present invention provide an electronic device to perform authentication according to surrounding information, and a method for authenticating a user to use the electronic device.

Additional features of the invention will be set forth in the description which follows, and in part will be apparent from the description, or may be learned by practice of the invention.

An exemplary embodiment of the present invention provides a device to authenticate a user, including: a user interface unit to receive a password input; a surrounding information detecting unit to detect surrounding information of the device; and an authentication unit to authenticate the password input and to determine whether the surrounding information matches preset surrounding information.

An exemplary embodiment of the present invention provides a device to perform an authentication, including: a user interface unit to receive an authentication input including a password; an authentication condition determining unit to determine whether an authentication condition is satisfied, based on information about the device; a password identification unit to identify the password from the authentication input, based on whether the authentication condition is satisfied; and an authentication unit to authenticate the password in response to a determination that the authentication condition is satisfied.

An exemplary embodiment of the present invention provides a method for performing authentication, including: receiving an authentication input for authenticating a user; determining whether an authentication condition is satisfied, based on surrounding information of a device; and authenticating the authentication input.

An exemplary embodiment of the present invention provides a method for performing an authentication, including: receiving an authentication input including a password; identifying the password from the authentication input, based on whether an authentication condition is satisfied, the authentication condition based on surrounding information of a device; and authenticating the password.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an electronic device having an unlock function based on surrounding information according to an exemplary embodiment of the present invention.

FIG. 2 is a diagram illustrating an example of lock settings according to an exemplary embodiment of the present invention.

FIG. 3 is a table showing examples of surrounding information according to an exemplary embodiment of the present invention.

FIG. 4 is a diagram illustrating an example of an unlock process using time information according to an exemplary embodiment of the present invention.

FIG. 5 is a diagram illustrating an example of a unlock process using direction information according to an exemplary embodiment of the present invention.

FIG. 6 is a diagram illustrating an example of an unlock process using touch information according to an exemplary embodiment of the present invention.

FIG. 7 is a diagram illustrating an example of an unlock process using motion information according to an exemplary embodiment of the present invention.

FIG. 8 is a flowchart illustrating a method for unlocking an electronic device using surrounding information according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

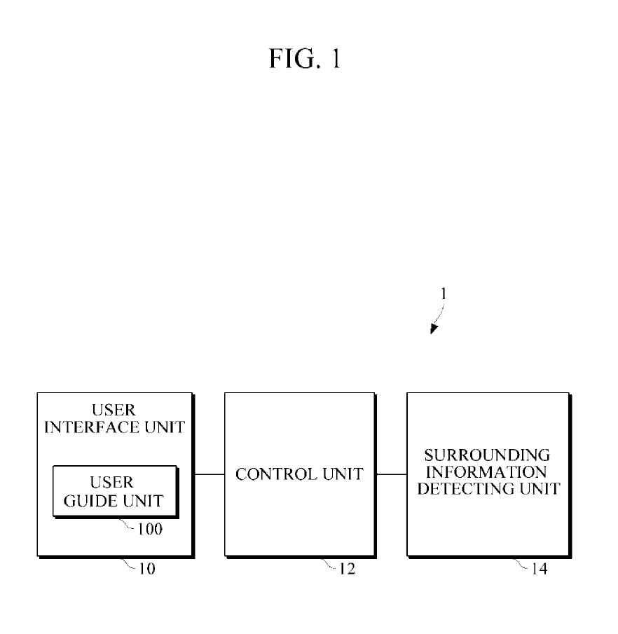

FIG. 1 is a diagram illustrating an electronic device having an unlock function based on surrounding information according to an exemplary embodiment.

Referring to FIG. 1, electronic device 1 may include a user interface unit 10, a control unit 12 and a surrounding information detecting unit 14. The user interface unit 10 may include a user guide unit 100.

The electronic device 1 may refer to a device that provides a lock and unlock function for preventing other users from using the device without satisfying an authentication process. For example, the electronic device 1 may be a laptop computer, a desktop computer, a mobile phone, or a portable multifunction device including a smartphone and a tablet computer.

According to an exemplary embodiment, an unlock method may use surrounding information, and may prevent recognition of the password even when the authorized user inputs the password if a surrounding information condition is not satisfied. The surrounding information may include sensing information acquired by one or more sensors of the electronic device, device status information, and the like. For example, the surrounding information may include at least one of time information, motion information, direction information, luminance information, color information, voice information and touch information. Specifically, a password and surrounding information of the device are combined to unlock the device. A device that uses simple passwords may be unlocked by other users by stealing a glance at the authorized user when the authorized user inputs the password to unlock the device. The electronic device 1 may utilize a password-based unlock method with a surrounding information detecting method using a sensor to provide the unlock method. The user of the electronic device may unlock the device with the surrounding information detecting method. However, unauthorized users may not recognize the unlocking method without knowing surrounding information set to the device because the surrounding information may not be directly recognizable. Hereinafter, the above characteristics will be described in more detail in conjunction with the configuration of each component.

The user interface unit 10 may receive a password to unlock the electronic device 1 from a user, and display an unlock result. Passwords may be any key combination, such as numbers only, or a combination of one or more letters, symbols, and numbers, which may be input to the electronic device 1. The user interface unit 10 may be provided on a touch screen of the electronic device 1.

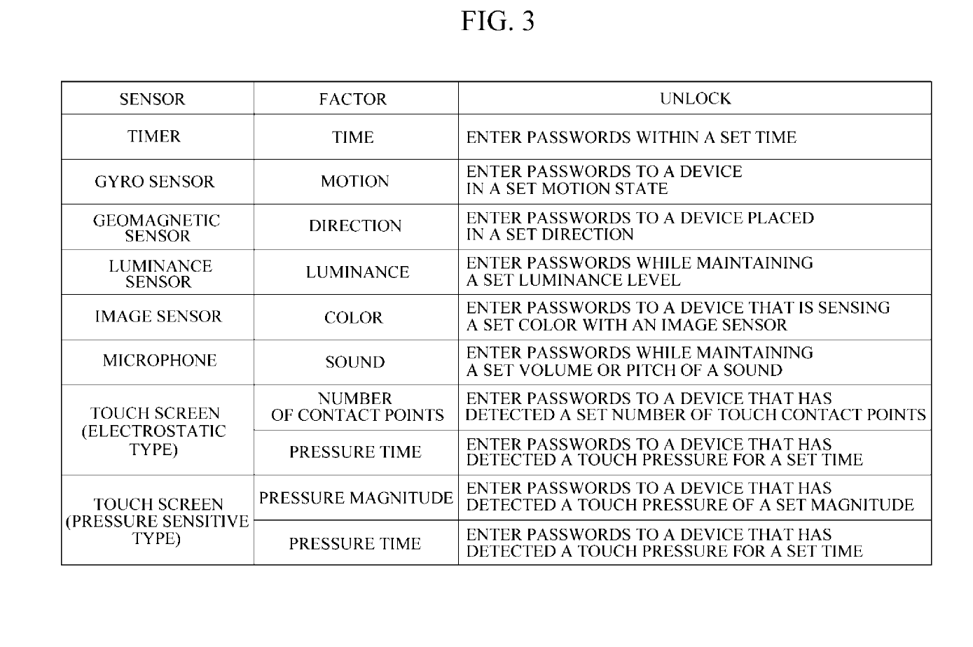

The surrounding information detecting unit 14 may detect surrounding information. Each type of surrounding information may be detected independently or in a combined manner. The surrounding information may include at least one of time information, motion information, direction information, luminance information, color information, voice information and touch information. The surrounding information may be detected by a corresponding sensor equipped in the electronic device 1. A more detailed description of the surrounding information will be provided later with reference to FIG. 3.

The control unit 12 may determine whether surrounding information detected by the surrounding information detecting unit 14 matches a previously set surrounding requirement upon receiving the password through the interface unit 10, and unlock the device if the surrounding information matches the surrounding requirement. The surrounding requirement may be set by the authorized user through the interface unit 10 during an unlocked state of the electronic device 1. An authorization procedure may be provided before allowing a modification of the surrounding requirement. For example, the user may be authorized to change the surrounding requirement if the user provides the password and surrounding information for the unlocking process or if the user inputs a different password for the modification of the surrounding requirement. The surrounding requirement may refer to a setting of one or more types of surrounding information for authorizing the password input. For example, a password input of a user may be ignored by the control unit 12 if the surrounding information of the electronic device 1 does not match the surrounding requirement (the surrounding information setting). The control unit 12 may activate a recognition function for a password input if the surrounding information matches the surrounding requirement. Thus, the control unit 12 may recognize a portion of the password input that is inputted while the surrounding information of the electronic device 1 matches the surrounding requirement. Further, the control unit 12 may separately authenticate the password and the surrounding information. For example, if the electronic device 1 receives an input in a locked state, the control unit 12 may determine whether the surrounding information matches the surrounding requirement, and may determine whether the correct password is input by a user and the correct password is input during the surrounding information matches the surrounding requirement. The control unit 12 may determine whether the surrounding information matches the surrounding requirement first, and may determine whether the correct password is input by a user only if the surrounding information matches the surrounding requirement. Similarly, the control unit 12 may determine whether the correct password is input by a user first, and may determine if the surrounding information matches the surrounding requirement only if the correct password is input by a user.

The control unit 12 may unlock the device if the surrounding information is matched with the previously set surrounding requirement and the password is identical to a preset password. Further, the control unit 12 may hold the password authentication operation for a determined period of time or put the electronic device 1 in a secured state if a wrong password is inputted more than a certain number of times. In the secured state, the electronic device 1 may provide a secured authentication process to unlock the secured state. For example, in the secured state, the electronic device 1 may provide a secured user interface to input a secured password. An authorized user may input the secured password into the secured user interface to unlock the secured state into a normal state. Further, preregistered user information such as social security number, zip code, and the like may be further requested to unlock the secured state. Further, the surrounding requirement may be disabled or the secured state may be unlocked if the electronic device 1 is determined to be located in a registered area or connected to a certain device or network. For example, the surrounding requirement may be disabled or the secured state may be unlocked if the electronic device 1 is located within the authorized user's home or connected to a registered personal computer of the authorized user or Wi-Fi access point of the authorized user.

The user guide unit 100 may display guidance information to assist the authorized user to enter a password according to the set surrounding requirement. The guidance information may indirectly provide a hint for the surrounding requirement and facilitate the password input for the authorized user who set the surrounding requirement. For example, if the surrounding information is time information, a timer is provided to enable the authorized user to recognize appropriate timeslot to input the password. If the surrounding information is direction information, a compass may be provided to indicate current direction of the electronic device 1. If the surrounding information is voice information, a microphone may be provided. If the surrounding information is color information, a camera may be provided.

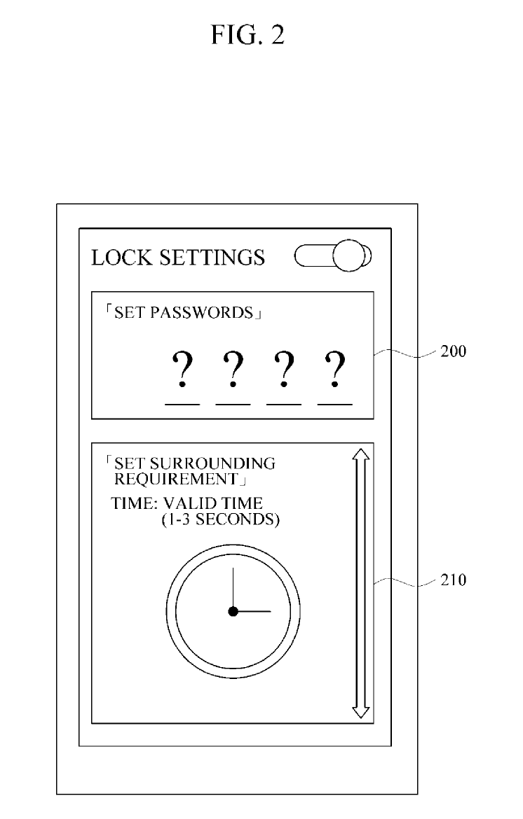

FIG. 2 is a diagram illustrating an example of lock settings according to an exemplary embodiment of the present invention. Referring to FIG. 1 and FIG. 2, the user interface unit 10 provides a password setting screen 200 and a surrounding requirement setting screen 210. For example, as shown in FIG. 2, the user may set a four-digit password in the password setting screen 200, and a valid timeslot for password input may be set to 1 to 3 seconds in the surrounding requirement setting screen 210 as the surrounding requirement. In this setting, the four-digit password must be input within 1 to 3 seconds.

FIG. 3 is a table showing examples of surrounding information according to an exemplary embodiment of the present invention. Referring to FIG. 1, FIG. 2 and FIG. 3, the surrounding information detecting unit 14 may detect surrounding information of the electronic device 1. The surrounding information may include at least one of time information, motion information, direction information, luminance information, color information, voice information, and touch information. The electronic device 1 may use a sensor included in the electronic device 1 to detect the surrounding information.

If the surrounding information is time information, the surrounding information detecting unit 14 detects a password input time. The time information may be time period information including the password input start time and password input completion time. In this case, the control unit 12 may determine whether a password is input within a preset time period. For example, the device may be unlocked if the password is correctly entered within the set timeslot of 1 to 3 seconds.

If the surrounding information is motion information, the surrounding information detecting unit 14 may detect motion or orientation of the electronic device 1 using an acceleration sensor or a gyro sensor. For example, the motion information may be obtained from a sensor of the electronic device 1 whether the electronic device 1 is in a horizontal position or vertical position. The control unit 12 determines whether the password is input while the device is in a preset motion or orientation state. For example, the electronic device 1 may be unlocked if correct password is input to the electronic device 1 that is in a horizontal position.

If the surrounding information is direction information, the surrounding information detecting unit 14 may detect a direction of the device through a geomagnetic sensor. The direction information may indicate four cardinal directions, such as north, south, east and west. The control unit 12 may determine whether the password is input in the electronic device 1 while the electronic device 1 is positioned in or facing a preset direction. For example, the electronic device 1 may be unlocked if correct password is input to the electronic device 1 that is being positioned to or facing to the north.

If the surrounding information is luminance information, the surrounding information detecting unit 14 may detect luminance of the surroundings of the electronic device 1 through a luminance sensor. The luminance information may indicate low-luminance information or high-luminance information. The control unit 12 may determine whether the password is input while the electronic device 1 is set to predefined luminance level. For example, the electronic device 1 may be unlocked if correct password is input to the electronic device 1 that is in a high-luminance state.

If the surrounding information is color information, the surrounding information detecting unit 14 may detect colors using an image sensor. The control unit 12 may determine whether the password is input while the electronic device 1 is in a predefined image state. For example, the electronic device 1 may be unlocked if a correct password is input to the electronic device 1 while the image sensor of the electronic device 1 is sensing a red color.

If the surrounding information is voice information, the surrounding information detecting unit 14 may detect a voice through a microphone. The control unit 12 may determine whether the password is input and a predetermined volume of voice has been detected. For example, the electronic device 1 may be unlocked if a correct password is input to the electronic device 1 once or while a predefined volume of voice has been detected from the microphone.

If the surrounding information is information on the number of touch contact points, the surrounding information detecting unit 14 may detect the number of contact points using a touch sensor, e.g., an electrostatic type touch sensor. The control unit 12 may determine whether the password is input once a predetermined number of touch points have been detected or while a number of concurrent touch points are detected by the electronic device 1. For example, the electronic device 1 may be unlocked if correct password is input after the electronic device 1 has detected a multi-touch of three fingers.

If the surrounding information is information on touch pressure time or the number of touches, the surrounding information detecting unit 14 may detect the touch pressure time using an electrostatic type or a pressure sensitive type sensor. The control unit 12 may determine whether the password is input once the electronic device 1 has been touched for a predetermined touch pressure time. For example, the electronic device 1 may be unlocked if a correct password is input after the electronic device 1 has detected a touch pressure for a predetermined time or three touch inputs.

If the surrounding information is touch pressure information, the surrounding information detecting unit 14 may detect touch pressure using a pressure sensitive touch sensor. The control unit 12 may determine whether the password is input once a preset range of touch pressure has been detected. For example, the electronic device 1 may be unlocked if a correct password is input after the electronic device 1 has detected the pressure of touch input between the preset range.

The surrounding information may be aforementioned time information, motion information, direction information, luminance information, color information, voice information, and touch information, or a combination of one or more of these types of surrounding information. For example, if the surrounding information is the combination of time information and motion information, the electronic device 1 may be unlocked if correct password is input within 3 to 5 seconds while the electronic device 1 is in the horizontal position or orientation. When correct password is input by a user, surrounding requirement corresponding to the time information and the motion information should be satisfied to unlock the electronic device 1. The above combination of the time information and the motion information among a plurality of surrounding information is exemplary, and the combination of surrounding information could be a different combination.

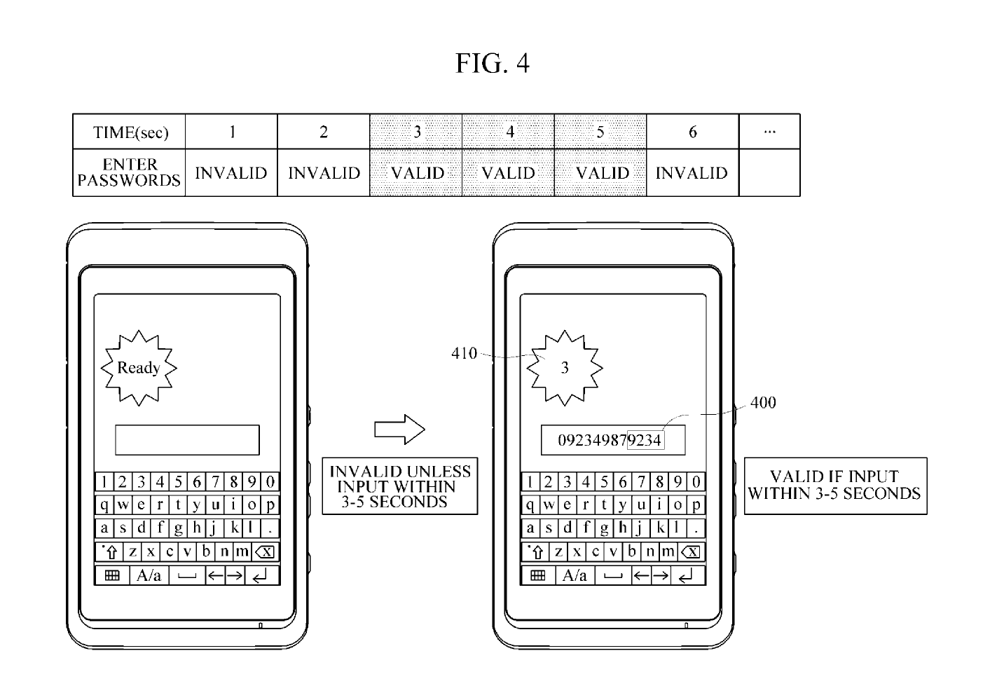

FIG. 4 is a diagram illustrating an example of an unlock process using time information according to an exemplary embodiment of the present invention. FIG. 4 will be described as if performed by electronic device 1 shown in FIG. 1, but is not limited as such.

Referring to FIG. 4, an electronic device 1 determines whether password is input within a predetermined time period. For example, as shown in FIG. 4, the electronic device 1 may be unlocked if the correct password, 9234, is input within 3 to 5 seconds.

In this process, guidance information may be displayed on the electronic device 1 to guide or assist the user to enter correct password according to preset surrounding requirement. For example, a timer 410 may be provided to assist the user to input correct password among other inputs for distracting others, and to remind the user of the type of surrounding information for the surrounding requirement.

In one example, the electronic device 1 may be configured to remain locked, but to allow a user to input a password if the predetermined surrounding requirements are not satisfied, thereby hiding the status that the surrounding requirement is not satisfied. For example, the electronic device 1 may be unlocked if the password is not entered within 3 to 5 seconds even though the password is identical to the preset password, 9234, as shown in the left side of FIG. 4. Yet, key input operation and input results may be displayed regardless of whether the surrounding requirement is met. Accordingly, it may be difficult for other users to recognize correct password and an additional surrounding requirement for unlock, and thus the electronic device 1 may be prevented from being unlocked by malicious users. The authorized user may input an input including the correct password and a distraction input. The distraction input may include a combination of key-inputs inputted while the surrounding requirement is not met. The distraction input may distract other users from recognizing the correct password and the surrounding requirement. Further, the correct password may be located between a first distraction input and a second distraction input in a sequential order, as shown in FIG. 4. Thus, other users may not recognize the correct password from an input of the authorized user that includes the first distraction input, the correct password, and a second distraction input. Further, the input of the authorized user may exclude at least one of the first distraction input, and a second distraction input. For example, the input of the authorized user may be “092349879234”, the first distraction input may be “09234987”, and the correct password 400 may be “9234”, as shown in FIG. 4. Referring to FIG. 4, if it is assumed that “09234” is input between 0 to 3 seconds and “9879234” is input between 3 to 5 seconds, the input “09234” may be ignored by the control unit 12 since the input “09234” is input during the surrounding requirement is not met. The input “987” from the “9879234” may be recognized as the first distraction input and the consecutive input “9234” from the “9879234” may be recognized as correct password by the control unit 12. The second distraction input may be received and displayed next to the “9879234”. Further, the input “09234” may be recognized as the first distraction input since the input “09234” is input during the surrounding requirement is not met. The control unit 12 may recognize the correct password “9234” from the input “9879234” inputted between 3 to 5 seconds if the four digits of the correct password is input consecutively. Further, the input “09234987” may be the first distraction input.

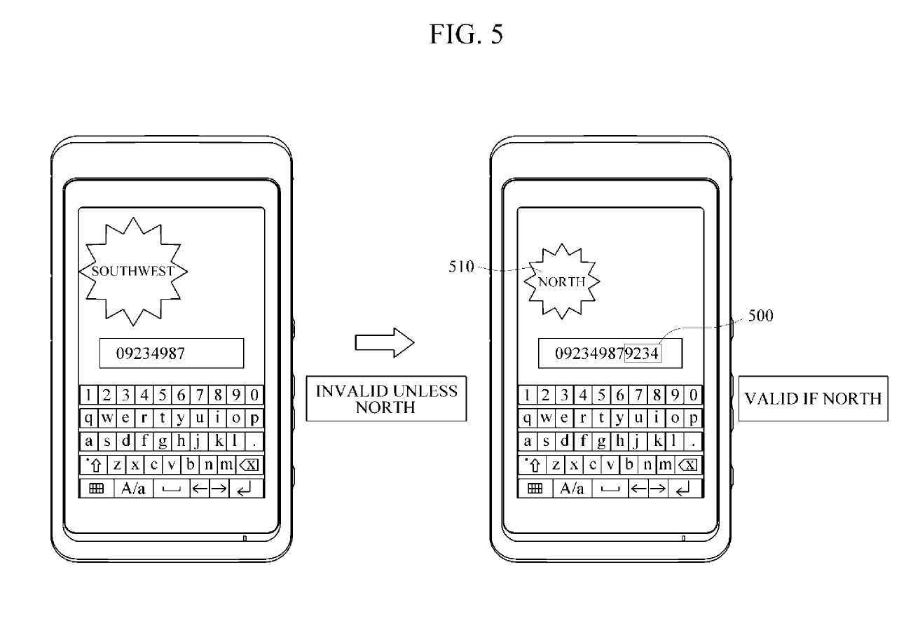

FIG. 5 is a diagram illustrating an example of a unlock process using direction information according to an exemplary embodiment of the present invention. FIG. 5 will be described as if performed by electronic device 1 shown in FIG. 1, but is not limited as such.

Referring to FIG. 5, an electronic device 1 determines whether a password is input while the electronic device is placed, arranged, or oriented in a preset direction. For example, as shown in FIG. 5, the electronic device 1 may be unlocked if the correct password, 9234, (reference numeral ‘500’) is input while the electronic device 1 faces toward the north 510.

In this process, the electronic device may display guidance information to assist a user to input password according to a preset surrounding requirement. For example, a compass may be displayed to indicate the direction information of the electronic device 1.

In one example, the electronic device 1 may be configured to remain locked, but to allow a user to enter password even though the preset surrounding requirement is not satisfied, thereby hiding the status that the surrounding requirement is not satisfied. For example, as shown in the left side of FIG. 5, the electronic device 1 may not be unlocked if a password is input while the electronic device 1 does not face toward the north even though the password is identical to a predefined password, 9234. However, key input operation and input results may be still displayed, as shown in FIG. 5. Hence, it is difficult for other users to know correct password and an additional surrounding requirement for unlock, and thus the electronic device 1 may be prevented from being unlocked by malicious users.

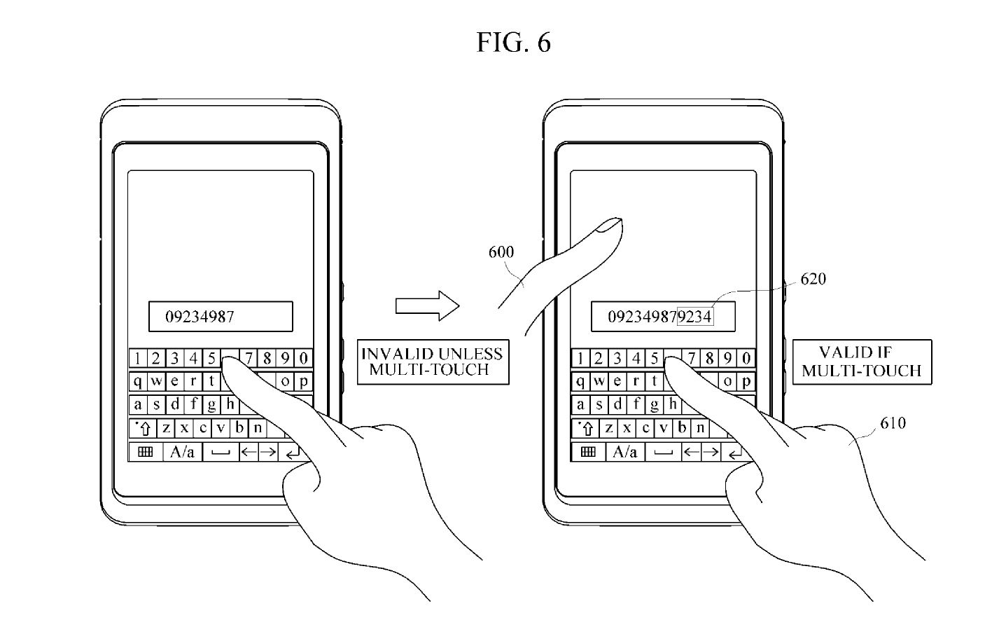

FIG. 6 is a diagram illustrating an example of an unlock process using touch information according to an exemplary embodiment of the present invention. FIG. 6 will be described as if performed by electronic device 1 shown in FIG. 1, but is not limited as such.

Referring to FIG. 6, an electronic device 1 determines whether a password is input once a predetermined number of contact points have been detected. For example, as shown in FIG. 6, the electronic device 1 may be unlocked if a correct password, 9234, (reference numeral ‘620’) is input once the multi-touch events 600 and 610 have been detected. Multi-touch events 600 and 610 may be concurrent, i.e. occurring during an overlapping time, sequential, or a combination thereof.

Further, the electronic device 1 may be configured to remain locked, but to allow a user to enter a password even though the preset surrounding requirement is not satisfied, thereby hiding the status that the surrounding requirement is not satisfied. For example, as shown in the left side of FIG. 6, the electronic device 1 may not be unlocked if a password is input when the two multi-touch events are not detected even though the password is identical to the preset password, 9234. However, key input operation and input results may be still displayed. Hence, it may be difficult for other users to know correct password and an additional surrounding requirement for unlock, and thus the electronic device 1 may be prevented from being unlocked by malicious users.

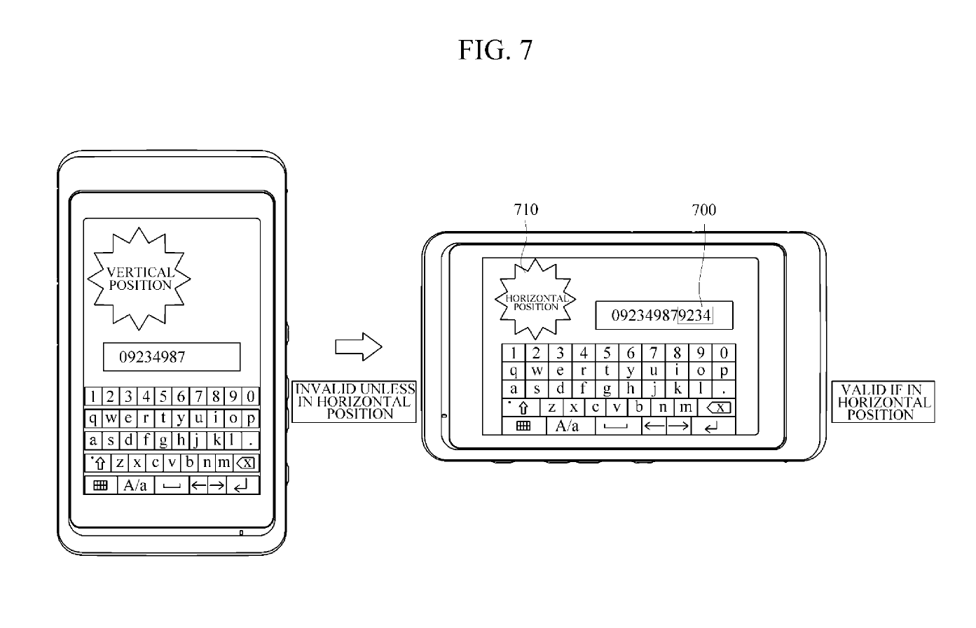

FIG. 7 is a diagram illustrating an example of an unlock process using motion information according to an exemplary embodiment of the present invention. FIG. 7 will be described as if performed by electronic device 1 shown in FIG. 1, but is not limited as such.

Referring to FIG. 7, an electronic device 1 determines whether a password is input while the electronic device 1 is in a preset motion state. For example, the electronic device 1 may be unlocked if correct password 9234 (reference numeral ‘700’) is input while the electronic device 1 is in a horizontal position 710.

Further, the electronic device 1 may be configured to remain locked, but to allow a user to enter a password if the preset surrounding requirement is not satisfied, thereby hiding the status that the surrounding requirement is not satisfied. For example, as shown in the left side of FIG. 7, the electronic device 1 may not be unlocked if a password is input while the electronic device 1 is not in a horizontal position even though the password is identical to the preset password, 9234. Yet, key input operation and input results may be still displayed. Thus, it may be difficult for other users to know correct password and an additional surrounding requirement for unlock, and thus the electronic device 1 may be prevented from being unlocked by malicious users.

The above unlock processes described with reference to FIG. 4, FIG. 5, FIG. 6, and FIG. 7 are exemplary, and it should be appreciated that an unlock process may vary. The unlock process may use, independently or in any combination of one or more of, time information, motion information, direction information, luminance information, color information, voice information, and touch information, each of which corresponds to preset surrounding information, as the surrounding requirement. For example, in use of the combination of direction information and time information as the surrounding information, the electronic device 1 may be unlocked if a correct password is entered within 3 to 5 seconds while the electronic device 1 faces toward the north. The combined surrounding requirements corresponding to the direction information and the time information may be satisfied to unlock the device, along with receipt of the correct password. However, the above combination of surrounding information is exemplary, and the combination may vary.

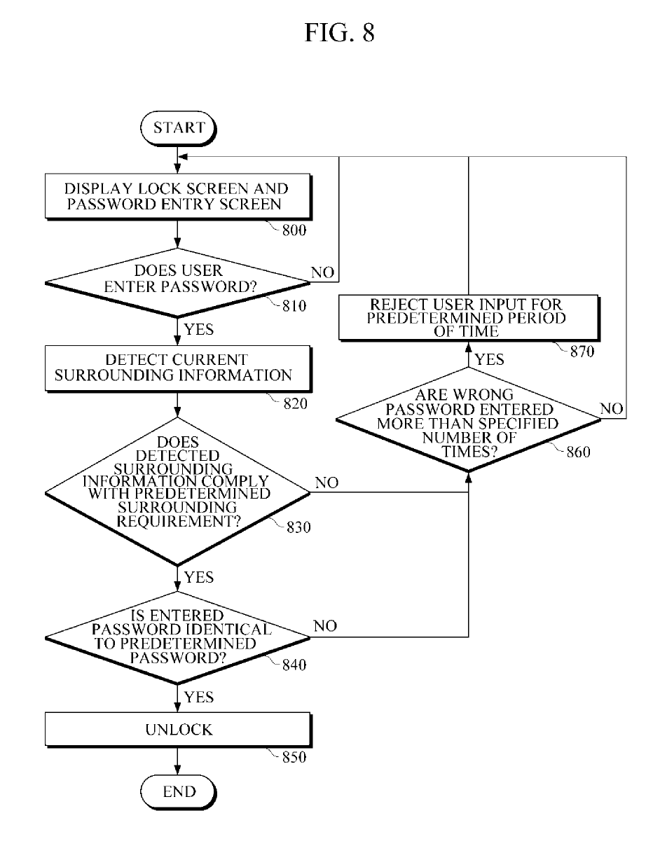

FIG. 8 is a flowchart illustrating a method for unlocking an electronic device using surrounding information according to an exemplary embodiment of the present invention. FIG. 8 will be described as if performed by electronic device 1 shown in FIG. 1, but is not limited as such.

Referring to FIG. 1 and FIG. 8, in response to setting a lock for the electronic device, the electronic device 1 displays a lock screen and a password entry screen in operation 800. Password is input by a user, e.g., by using key buttons or a touch screen to receive a user input, in operation 810. The electronic device 1 detects surrounding information in operation 820. The surrounding information includes at least one of time information, motion information, direction information, luminance information, color information, voice information, and touch information.

Then, the electronic device 1 determines whether the detected surrounding information complies with a preset surrounding requirement in operation 830. The surrounding requirement may be set by the user. If the surrounding information complies with the surrounding requirement, it is determined whether the entered password is identical to preset password in operation 840. If the entered password is identical to the preset password, unlocking the electronic device 1 is performed in operation 850.

If the surrounding information does not comply with the surrounding requirement or if the entered password is not identical to the preset password, it is determined whether wrong passwords are entered more than a certain number of times in operation 860. If it is determined that wrong passwords are entered more than the certain number of times, user input is rejected (and may be locked out for a determined period of time) or the electronic device 1 may be forcibly ended in operation 870.

As illustrated in the above exemplary embodiments, a lock and unlock method may be used by an authorized user of an electronic device, but may prevent malicious users from accessing the electronic device. The combination of a method to unlock the electronic device and a method of using surrounding information may reduce unauthorized device access, and may prevent data including personal information from being leaked.

In addition, surrounding information for locking and unlocking the electronic device includes at least time information, motion information, direction information, luminance information, color information, voice information, and touch information, which may be obtained by sensors included in the electronic device or sensors included in an additional device and provided to the electronic device.

Guidance information may be displayed to guide and assist the authorized user to enter a password according to a preset surrounding requirement.

Furthermore, the electronic device may be configured to remain locked, but to allow a user to still enter passwords if the preset surrounding requirements are not satisfied.

Further, the control unit 12 may include an authentication condition determining unit (not shown), a password identification unit (not shown), and an authentication unit (not shown). Among various operations of the control unit 12 described above, a portion of operations performed by the control unit 12 may be performed by the authentication condition determining unit, a password identification unit, and an authentication unit.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A device to authenticate a user, comprising:
a user interface unit to receive a password input;
a surrounding information detecting unit to detect surrounding information of the device; and
an authentication unit to authenticate the password input and to determine whether the surrounding information matches preset surrounding information.

2. The device of claim 1, further comprising a user guide unit to display assistance information to assist the user to recognize the surrounding information.

3. The device of claim 1, wherein the surrounding information comprises at least one of time information, motion information, direction information, luminance information, color information, voice information, and touch information.

4. The device of claim 1, wherein the preset surrounding information comprises at least one of valid timeslot information, motion information of the device, direction information of the device, and a number of concurrent touch inputs.

5. The device of claim 1, further comprising a control unit to determine whether a number of authentication failures is larger than a threshold number, and to reject the password input if the number of authentication failures is larger than the threshold number.

6. A device to perform an authentication, comprising:
a user interface unit to receive an authentication input comprising a password;
an authentication condition determining unit to determine whether an authentication condition is satisfied, based on information about the device;
a password identification unit to identify the password from the authentication input, based on whether the authentication condition is satisfied; and
an authentication unit to authenticate the password in response to a determination that the authentication condition is satisfied.

7. The device of claim 6, further comprising a user guide unit to display assistance information to assist a user to recognize the information about the device,
wherein the information about the device is surrounding information comprising at least one of time information, motion information, direction information, luminance information, s color information, voice information, and touch information.

8. The device of claim 6, wherein the authentication input further comprises a first distraction input received in sequential order with the password, and
wherein the first distraction input is received prior to the password or the first distraction input is received after receiving the password.

9. The device of claim 6, wherein the password identification unit extracts a valid portion of the authentication input that is inputted while the authentication condition is satisfied, and
the authentication unit authenticates the password if the password is included in the valid portion of the authentication input.

10. The device of claim 6, wherein the authentication unit rejects the authentication input if a number of authentication failures is larger than a threshold number.

11. A method for performing authentication, comprising:
receiving an authentication input for authenticating a user;
determining whether an authentication condition is satisfied, based on surrounding information of a device; and
s authenticating the authentication input.

12. The method of claim 11, wherein the surrounding information comprises at least one of time information, motion information, direction information, luminance information, color information, voice information, and touch information.

13. The method of claim 11, wherein the authentication input comprises a first distraction input and a password, and
wherein the first distraction input is positioned prior to the password or the first distraction input is positioned following the password.

14. The method of claim 11, further comprising determining whether a number of authentication failures is larger than a threshold number, and
initiating a secured authentication process if the number of authentication failures is larger than the threshold number.

15. The method of claim 11, wherein the authentication input comprises a first input portion received while the authentication condition is not satisfied and a second input portion received while the authentication condition is satisfied, and wherein the method further comprises:
activating the second input portion if the second input portion is received while the authentication condition is satisfied; and
authenticating the second input portion by determining whether a correct password is included in the second input portion.

16. A method for performing an authentication, comprising:
receiving an authentication input comprising a password;
identifying the password from the authentication input, based on whether an authentication condition is satisfied, the authentication condition based on surrounding information of a device; and
authenticating the password.

17. The method of claim 16, wherein the authentication input comprises a first distraction input and the password, and
wherein the first distraction input is received prior to the password or the first distraction input is received after receiving the password.

18. The method of claim 16, wherein the authentication input further comprises a second distraction input, and
the first distraction input is received prior to the password and the second distraction input is received after receiving the password.

19. The method of claim 16, further comprising:
determining whether the authentication condition is satisfied, and
extracting a valid portion of the authentication input that is inputted while the authentication condition is satisfied,
wherein authenticating the password is performed if the password is included in the valid portion of the authentication input.

20. The method of claim 19, wherein the authentication condition is satisfied if detected surrounding information matches preset surrounding information.

21. The method of claim 20, wherein the surrounding information comprises sensing information of at least one of a timer, a gyro sensor, a geomagnetic sensor, a luminance sensor, an image sensor, a microphone, and a touch screen.

22. The method of claim 16, further comprising displaying assistance information corresponding to the authentication condition.
